(19) United States
(12) Patent Application Publication
(10) Pub. No.: US 2015/0032512 A1
(43) Pub. Date: Jan. 29, 2015

(54) METHOD AND SYSTEM FOR OPTIMIZING PRODUCT INVENTORY COST AND SALES REVENUE THROUGH TUNING OF REPLENISHMENT FACTORS

(71) Applicant: Teradata Corporation, Dayton, OH (US)

(72) Inventor: Arash Bateni, Toronto (CA)

(21) Appl. No.: 14/444,112

(22) Filed: Jul. 28, 2014

Related U.S. Application Data
(60) Provisional application No. 61/858,912, filed on Jul. 26, 2013.

(51) Int. Cl. G06Q 30/02; G06Q 10/06

(52) U.S. Cl. CPC G06Q 30/0206; G06Q 10/067
USPC 705/7.35

(57) ABSTRACT

A method and system for predicting the impact of replenishment levers on product service level, lost sales, and on-shelf availability for a retailer. The method and system models cost and revenue elasticity curves for a product or group of products and analyzes the cost and revenue elasticity curves, measures the impact of tuning the replenishment levers on inventory cost and sales revenue, and identifies values for the product replenishment levers to optimize replenishment system policies and product profitability.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/858,912, entitled “METHOD AND SYSTEM FOR OPTIMIZING PRODUCT INVENTORY COST AND SALES REVENUE THROUGH TUNING OF REPLENISHMENT FACTORS,” filed on Jul. 26, 2013, by Arash Bateni.

### FIELD OF THE INVENTION

The present invention relates to methods and systems for optimizing product inventory cost and sales revenue.

### BACKGROUND OF THE INVENTION

FIG. 1 provides an illustration of a retail demand/supply chain from a customer 101 to a retail store 103, retail distribution center/warehouse 105, manufacturer distribution center/warehouse 107, manufacturer 109 and supplier 111. Arrows 115 are used to illustrate communication between the demand/supply chain entities. A demand forecasting and replenishment system, identified by reference numeral 151, includes product demand forecasting, planning and replenishment applications executed on a server 153 to determine store order quantities 155 and distribution center forecasts 157, and provides for the synchronization of the warehouse/distribution center replenishment system with the replenishment ordering system from their supported stores.

Demand forecasting and replenishment system 151 may be implemented within a three-tier computer system architecture as illustrated in FIG. 2. The three-tier computer system architecture illustrated in FIG. 2 is a client-server architecture in which the user interface, application logic, and data storage and data access are developed and maintained as independent modules, most often on separate platforms. The three tiers are identified in FIG. 2 as presentation tier 201, application tier 202, and database access tier 203.

Presentation tier 201 includes a PC or workstation 211 and standard graphical user interface enabling user interaction with the DCM application and displaying DCM output results to the user. Application tier 203 includes an application server 253 hosting demand forecasting and replenishment software application 214. Database tier 203 includes a database server containing a database 216 of product price and demand data accessed by the demand forecasting and replenishment software application 214.

Optimizing the replenishment policies is a paramount problem for the largest retailers in the world. The optimization consists of tuning a combination of interdependent replenishment parameters (levers) such as lead time, review time, pack-size, vendor minimum, safety stock, minimum on shelf, and target service level. Changing each of these parameters would impact the profitability of the retailer in two ways:

a. Impact on Inventory Cost: the amount of inventory carried, which includes the cost of storage, capital, insurance and labor.

b. Impact on Sales Revenue: replenishment levers indirectly impact the on-shelf-availability of the products, and hence the service level and lost sales.

FIG. 3 illustrates exemplary revenue and cost elasticity curves, identified by reference numerals 301 and 303, respectively, indicating how sales revenue and inventory cost are affected in response to adjustments of any of the replenishment levers. For simplicity, one horizontal axis is used for the levers. In practice, this is a multi-lever optimization and one axis is needed per lever. The optimum set of levers corresponds to the point of maximum profit, i.e., sales revenue minus inventory cost.

In order to optimize the replenishment system, the sales revenue curve 301 and inventory cost elasticity curve 303 need to be determined, and an optimal relationship between the two curves identified.

Generally, inventory units are directly determined by the replenishment levers, and inventory carrying cost can thereby be calculated by employing the corresponding coefficients for the cost of capital (interest rate), inventory handling cost, labor cost, insurance premiums, etc. There are currently established science and methods available to determine the impact of safety stock, minimum on shelf, pack-size, vendor minimum, lead time and review time on the inventory units at stores as well as distribution centers.

However, to date, there has been no comprehensive method available to predict the impact of replenishment levers on service level, lost sales, or on shelf availability of the retailers. As a result, retailers are currently capable of quantifying the cost of their replenishment policies, but are unable to identify the corresponding upside, or the revenue impact of their policies. This has of course led to an inability of replenishment experts to mathematically model and optimize replenishment policies for retail businesses.

A novel methodology for predicting revenue elasticity curves as a function of replenishment levers, and optimizing replenishment policies for retail businesses is described below.

### BRIEF DESCRIPTION OF THE DRAWINGS

FIG. 1 provides an illustration of a product supply/demand chain from a supplier and manufacturer to a retail store and customer.

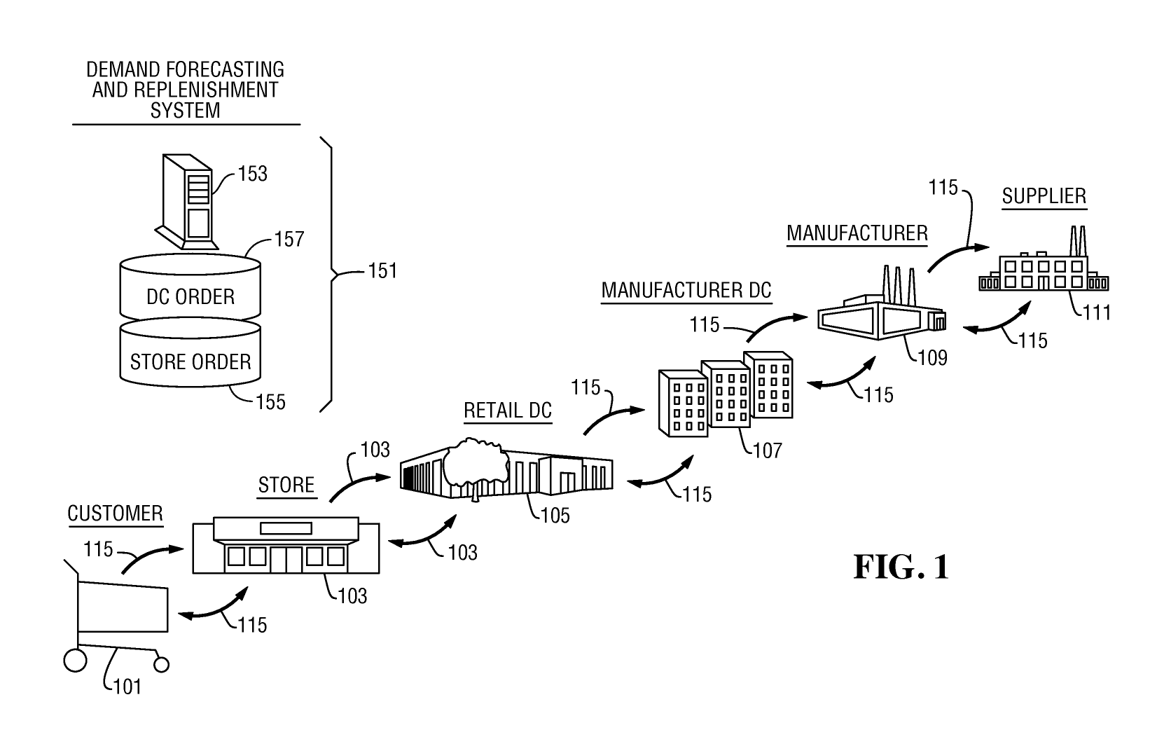

FIG. 2 provides a high level architecture diagram of a web-based three-tier client-server computer system architecture.

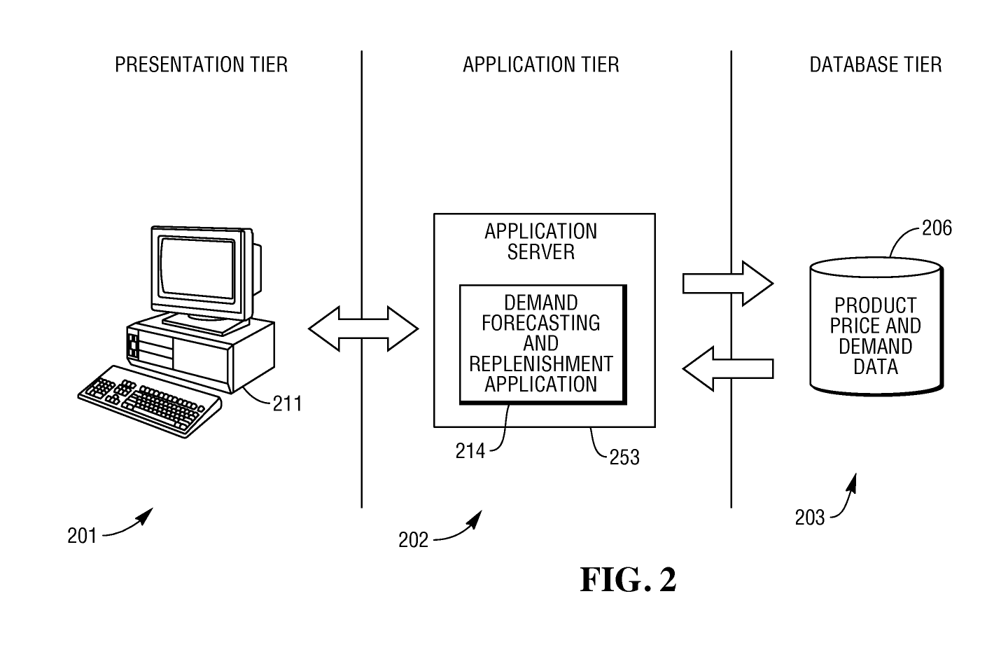

FIG. 3 illustrates exemplary revenue and cost elasticity curves indicating how sales revenue and inventory cost are affected in response to adjustments of replenishment levers.

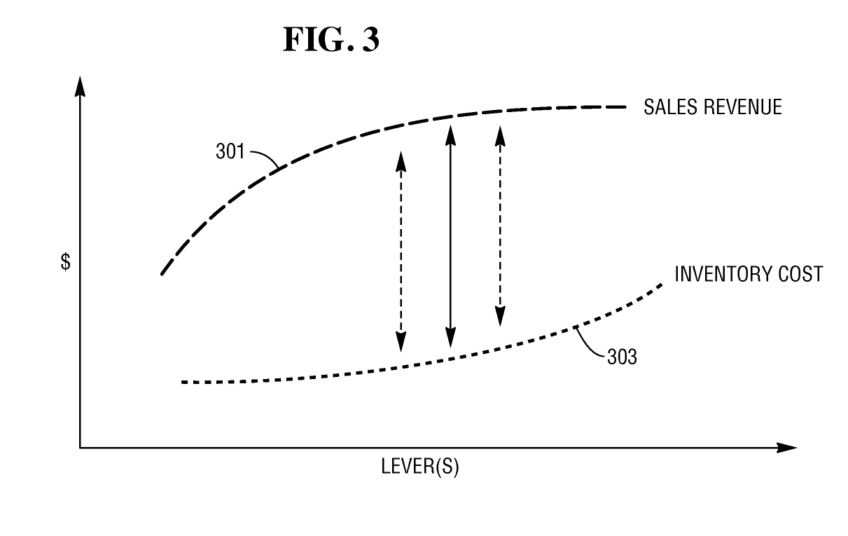

FIG. 4 illustrates exemplary density and cumulative distribution of demand curves for a category of products.

FIG. 5 is a flow diagram illustrating the process for identifying optimal values for replenishment levers in accordance with the present invention.

FIG. 6 provides a set of graphs illustrating demand distributions of a product during regular weeks, promotional weeks, and out-of-stock weeks.

FIG. 7 provides an illustration of sales trends for a product.

FIG. 8A provides an illustration of seasonality of sales for a product, and

FIG. 8B provides an illustration of sales and sales with seasonal adjustment for a product.

FIG. 9 provides an illustration of cumulative demand distributions calculated for different groups of product-locations.

FIG. 10 illustrate a demand distribution for an outlier product item-location.

FIG. 11 illustrates the risk of too little or too much aggregation across a product-location hierarchy when aggregating product demand data.

FIG. 12 illustrates the results of the application of the methodology described herein to selected groups of product categories, showing how inventory units and out-of-stock % can be calculated based on any give set of replenishment levers.

### DESCRIPTION OF THE INVENTION

Modeling the demand distribution is at the core of the new methodology. By modeling the demand distribution for the duration of an inventory cycle, i.e., the time between receiving two shipments at store, and cross-joining the demand distribution against the available on-shelf inventory, it is possible to determine potential lost sales or service level.

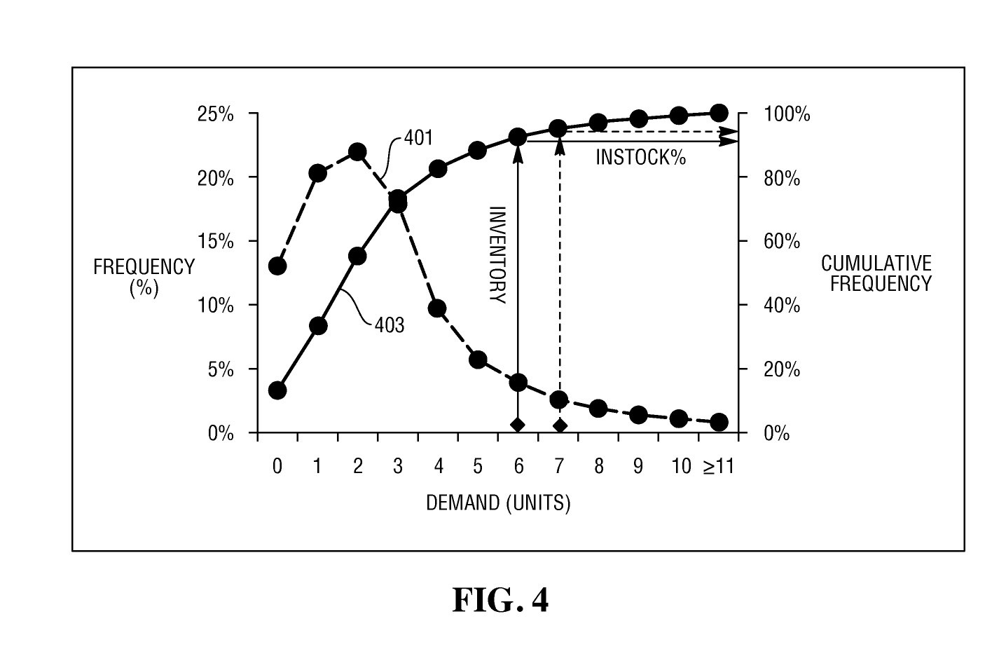

FIG. 4 shows the density 401 and cumulative distribution 403 of demand for a given category of products. Cross joining the demand distribution curves against number of units of available on shelf inventory results in the sales metrics such as In-stock %, Service Level and Lost Sales.

Demand density curve 401, plotted against the left axis, Frequency (%), illustrates the relative likelihood for the demand variable to take on a given value. Cumulative distributive curve 403, plotted using the right axis, Cumulative Frequency, shows the probability that the demand variable will be less than or equal to a specified value. Since it is a cumulative function, the cumulative distributive curve shows the sum of the probabilities that the variable will have any of the values less than the stated value. Referring to cumulative distribution curve 403, it is seen that the likelihood of selling six or less units is 94%. Thus, maintaining an on-hand inventory (OH) of six units results in a likelihood of having adequate inventory to meet demand of 94%, and a possibility of encountering an out-of-stock (OOS) situation of 6%.

Considering that the number of units of on shelf inventory is a direct result of the replenishment levers, sales metrics can be calculated for any given set of the levers. Using this holistic logic, combination of sales (revenue), inventory (cost) and replenishment levers can be modeled as a single integrated set of functions f( ) and g( ):

On shelf inventory units=f(replenishment levers), and

Sales Metrics=g(inventory units), thus

Sales Metrics=g(f(replenishment levers)).

For example, FIG. 4 shows that if the replenishment levers change in a way that the number of on shelf inventory increases from 6 to 7 units, the In-stock %, i.e., the cumulative frequency, is increased from 94% to 96%. The impact on lost sales and overall revenue can be similarly calculated.

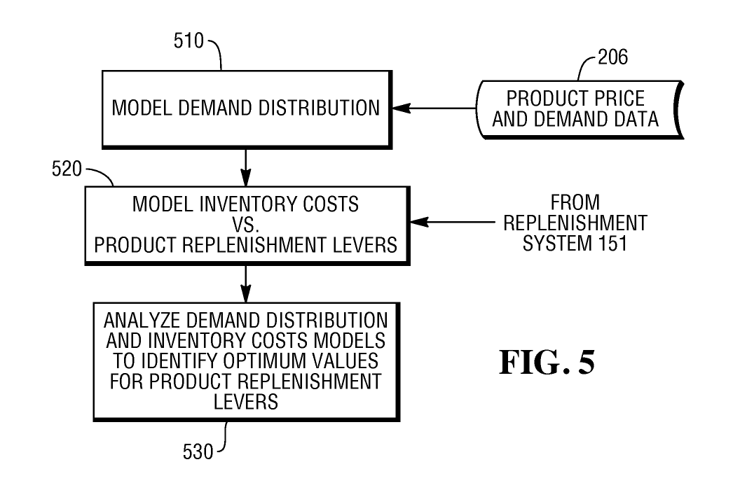

The process for identifying optimal values for replenishment levers is illustrated in the flow diagram of FIG. 5. The process depends upon proper modeling of demand distribution, as shown in step 510. Historical sales data 206 is used for this purpose.

Information concerning replenishment levers and inventory units are obtained from replenishment system 151, and inventory carrying cost are thereby calculated by employing the corresponding coefficients for the cost of capital, inventory handling cost, labor cost, insurance premiums, etc., as shown in step 520. There are currently established science and methods available to determine the impact of safety stock, minimum on shelf, pack-size, vendor minimum, lead time and review time on the inventory units at stores as well as distribution centers.

In step 530, the demand distribution and inventory cost models are analyzed to identify the optimal values for the product replenishment levers to improve the profitability of the retailer.

### Demand Modeling

As stated above, proper modeling of demand distribution is at the core of this methodology. Various techniques and considerations are essential to derive accurate and reliable distribution of demand.

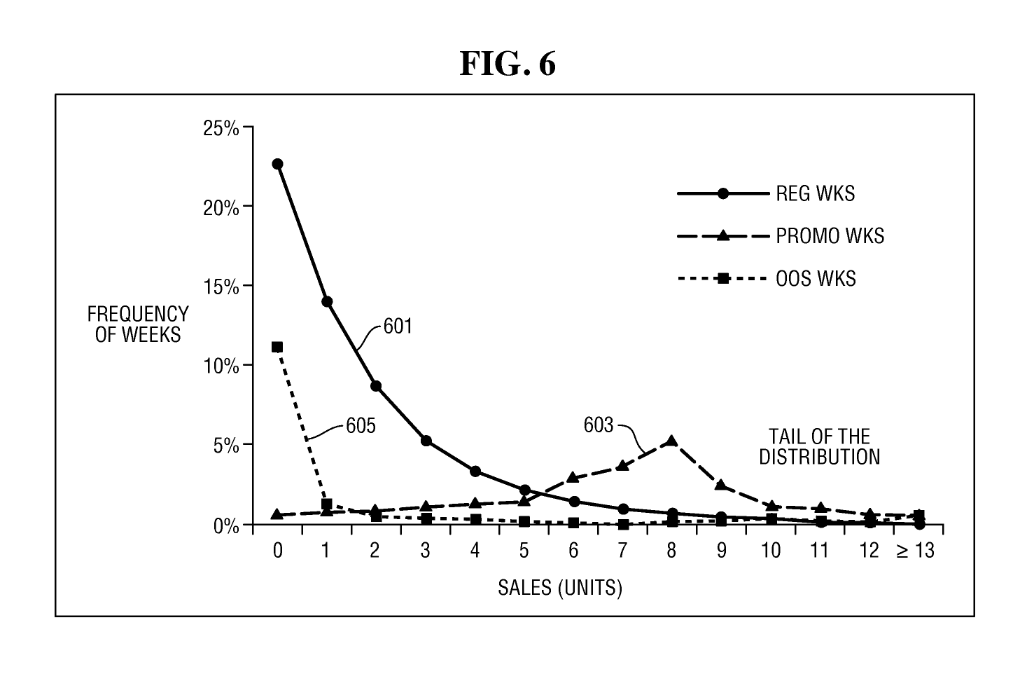

FIG. 6 provides a set of graphs illustrating demand distributions of a product during regular weeks (graph 601), promotional weeks (graph 603), and out-of-stock weeks (graph 605). The graphs show that the different types of demand have distinctly different distributions. Proper handling of out-of-stock and promotional weeks is necessary for accurate modeling of demand distribution.

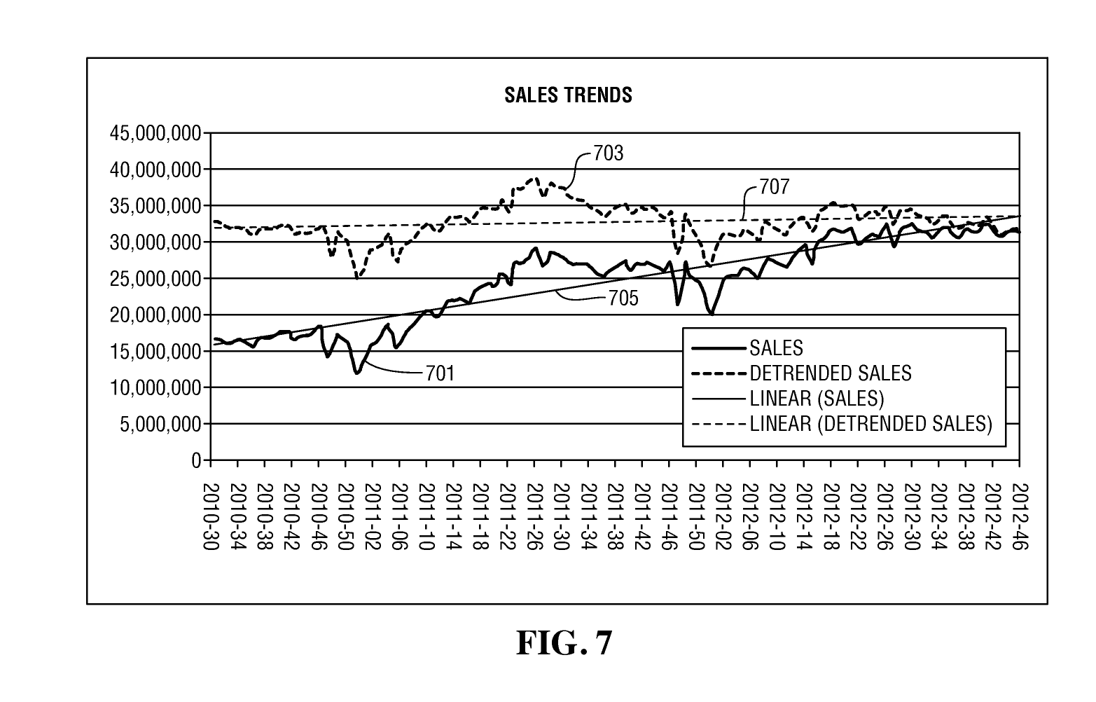

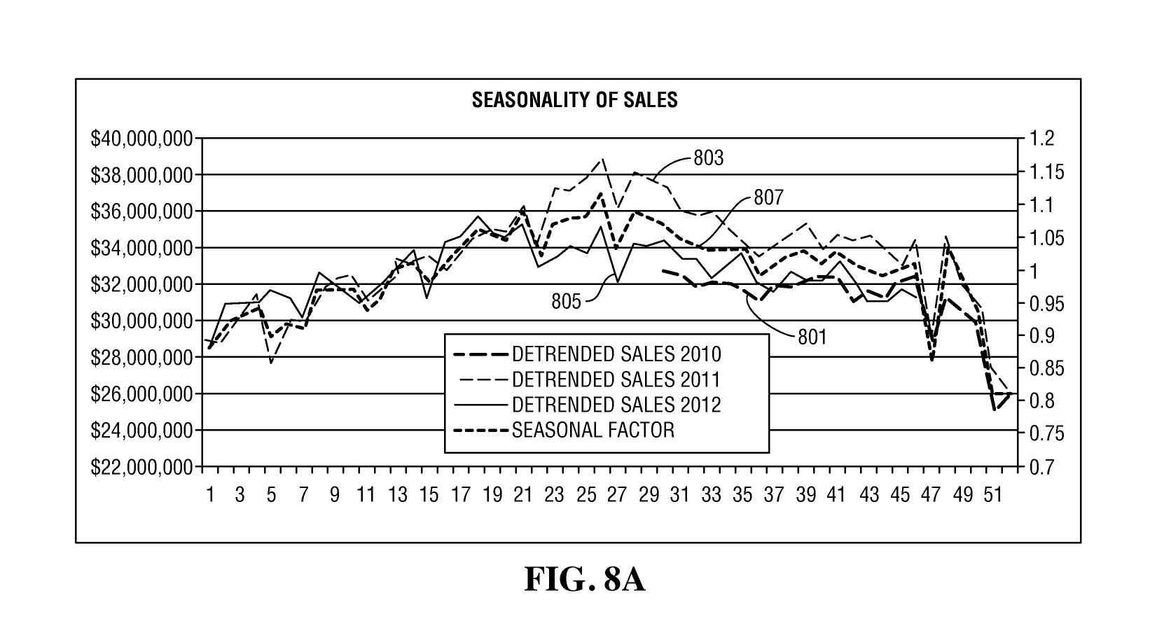

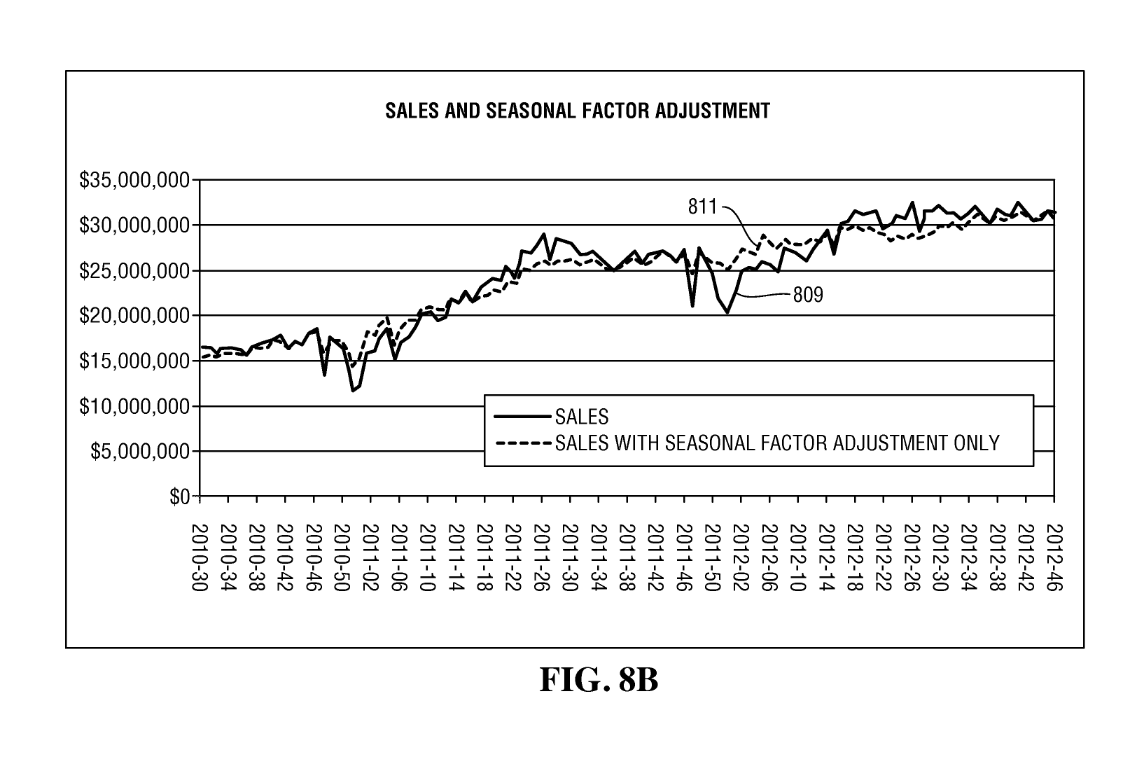

Accurate calculation of the distribution tail, i.e., the rightmost portion of the graphs, is essentially important since most practical optimizations are done over the tail of the demand distribution. This can be challenging as typically the fewest number of data points are available to construct the tail. In order to translate sales data into demand distribution the following factors must be considered:
Out-of-stocks: sales do not represent potential demand during OOS weeks.
Promotions: promotions are different from one another and can have different demand distributions, so they should be excluded from the demand history.
Trend: older sales data do not represent current demand, so trend adjustment is necessary. FIG. 7 provides an illustration of sales trends for a product with graphs of sales 701, detrended sales 703, linearized sales 705, and linearized detrended sales 707.
Seasonality of demand, the gradual change in demand distribution from week to week over a sales year, needs to be adjusted. FIG. 8A provides an illustration of seasonality of sales for a product with graphs of detrended sales over three tears, identified by reference numerals sales 801, 803, and 805. Graph 807 shows the seasonal factors for the product. FIG. 8B provides an illustration of sales (graph 809) and sales with seasonal adjustment (graph 809). Calculating and adjusting the sales seasonality is essential for proper modeling of demand distribution.

Separate demand distributions need to be calculated for different product categories and groups of stores (locations). Calculation of demand distribution at Store-SKU (Stock Keeping Unit) level may not be feasible when a limited amount of data does not provide enough data points to accurately calculate the tail of demand distribution. Calculation of demand distribution as high levels of product-store hierarchy is also undesirable, since it requires mixing distinctly different product-stores. Demand distribution can be calculated for any group of product-locations. Identifying the right group of product-locations is essential for accuracy of demand models.

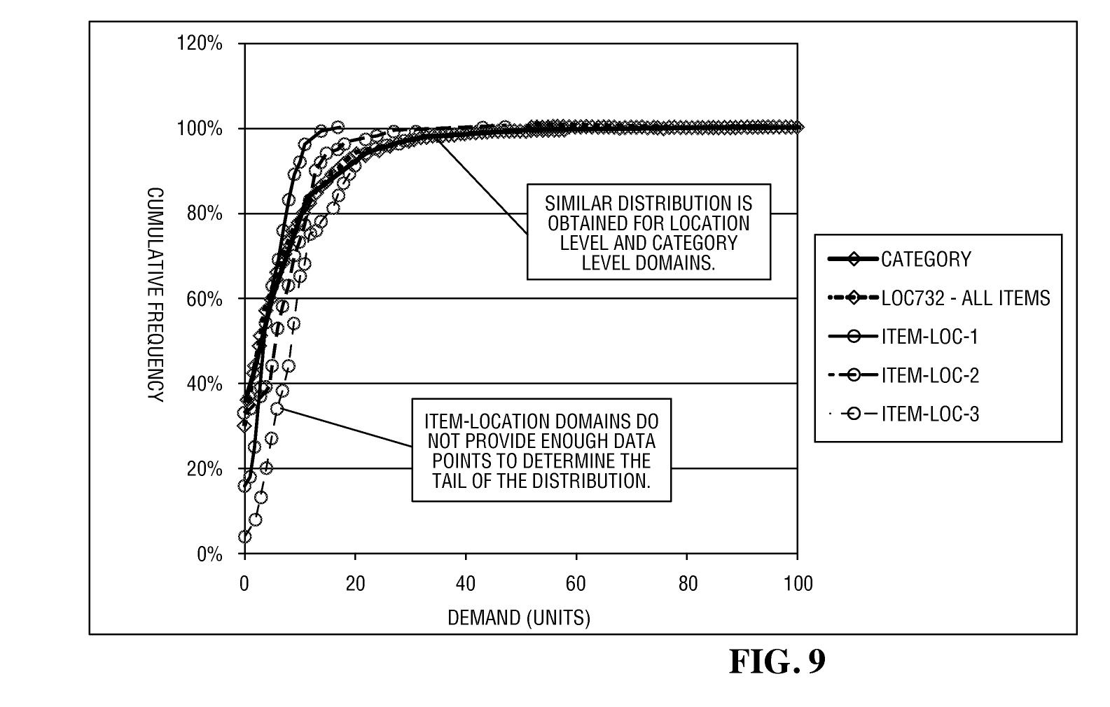

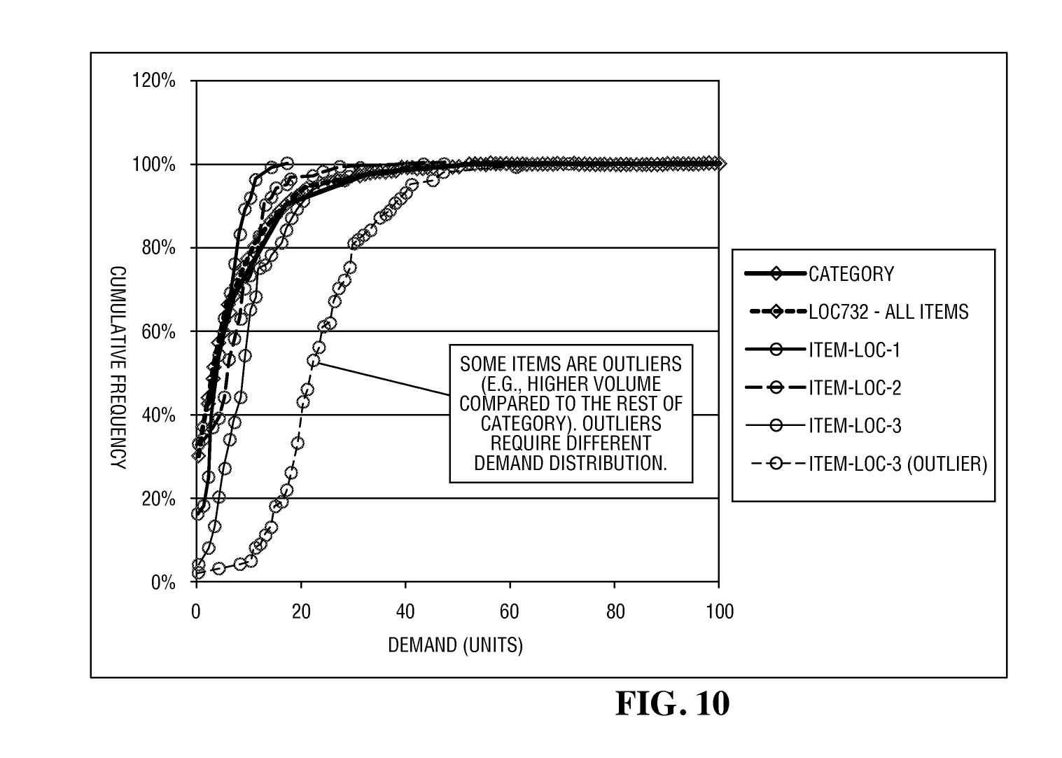

FIG. 9 provides an illustration of cumulative demand distributions calculated for different groups of product-locations. The graph shows that it is not possible to determine the tail of the distribution at item-location level. Enough data points to construct the tail is however available at Category level and for all items of a give location (store). FIG. 10 illustrates that certain item-locations, e.g., Item-Loc-3, demonstrate distinctly different demand distributions. These situations need to be identified as outliers and modeled separately.

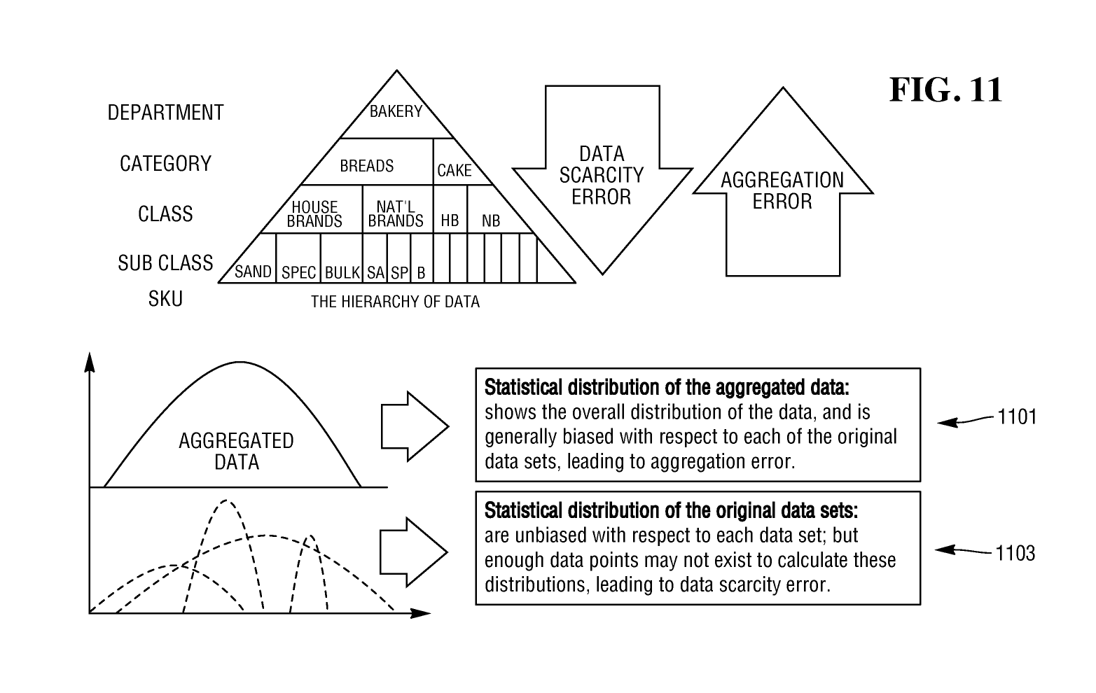

FIG. 11 illustrates the risk of too little or too much aggregation across product-location hierarchy. Too little aggregation leads to data scarcity while too much aggregation mixes different types of products/stores. Optimum level of aggregation is essential.

### Illustration of Results

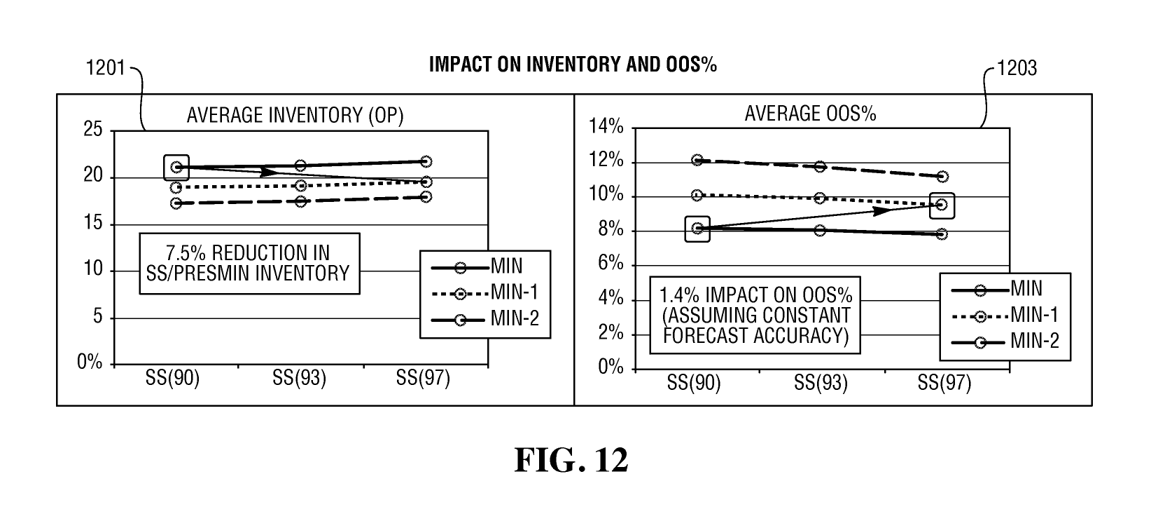

FIG. 12 illustrates the results of the application of the above described methodology to selected groups of product categories, showing how inventory units and out-of-stock % can be calculated based on any give set of replenishment levers.

As illustrated in FIG. 12, a retailer adjusts two levers, safety stock and minimum on shelf, at the same time to examine the impact on Average Inventory Units (a measure of cost) and Average Out-Of-Stock % (a measure of lost sales or revenue). In this example the safety stock (SS) is set to 90%, 93% and 97%, and the minimum on-shelf units is set to existing value (Min), existing value minus one (Min−1), and existing value minus two (Min−2). Using the presented methodology, the retailer can predict, for the first time, that a 7.5% reduction in inventory (lower cost) is possible at the expense of 1.4% increase in out-of-stock situation. Using such quantitative trade-offs the optimization of replenishment factors becomes possible.

The predictive model presented here relates the replenishment policies to inventory units and sales metrics, and enables the retailers to perform what-if analysis in order to determine the optimum set of the replenishment levers.

Instructions of the various software routines discussed herein, are stored on one or more storage modules in the system described herein and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of the invention has been presented for purposes of illustration and description. It is not intended to be exhaustive or to limit the invention to the precise form disclosed. Many alternatives, modifications, and variations will be apparent to those skilled in the art in light of the above teaching

What is claimed is:

1. A computer-implemented method for managing product replenishment levers to increase product profitability, the method comprising the steps of:
maintaining, in a data storage device, a database of historical demand values for a product;
determining, by a computer in communication with said data storage device, a demand distribution model for said product from said historical demand values;
determining, by said computer, an inventory costs model for said product from replenishment levers and inventory data for said product obtained from a replenishment system;
analyzing, by said computer, said demand distribution model and said inventory costs model to identify values for the product replenishment levers to increase product profitability.

2. The computer-implemented method according to claim 1, wherein said step of determining said inventory costs model comprises determining inventory carrying cost by analyzing at least one of cost of capital, inventory handling cost, labor cost, and insurance premiums.

3. The computer-implemented method according to claim 1, wherein said replenishment levers comprise at least one of lead time, review time, product pack-size, vendor minimum product order quantity, safety stock product quantity, minimum on shelf product quantity, and target service level.

4. The computer-implemented method according to claim 1, wherein said historical demand values used to determine said demand distribution model comprises historical regular demand values for said product.

5. The computer-implemented method according to claim 1, wherein said historical demand values used to determine said demand distribution model comprises historical promotional demand values for said product.

6. The computer-implemented method according to claim 1, wherein said historical demand values used to determine said demand distribution model comprises historical values during out-of-stock periods for said product.

7. The computer-implemented method according to claim 1, wherein said product comprises an aggregation of related product items.

8. A system for managing product replenishment levers to increase product profitability, comprising:
a data storage device containing a database of historical demand values for a product; and
a computer in communication with said data storage device, for:
determining a demand distribution model for said product from said historical demand values;
determining an inventory costs model for said product from replenishment levers and inventory data for said product obtained from a replenishment system;
analyzing said demand distribution model and said inventory costs model to identify values for the product replenishment levers to increase product profitability.

9. The system according to claim 8, wherein determining said inventory costs model comprises determining inventory carrying cost by analyzing at least one of cost of capital, inventory handling cost, labor cost, and insurance premiums.

10. The system according to claim 8, wherein said replenishment levers comprise at least one of lead time, review time, product pack-size, vendor minimum product order quantity, safety stock product quantity, minimum on shelf product quantity, and target service level.

11. The system according to claim 8, wherein said historical demand values used to determine said demand distribution model comprises historical regular demand values for said product.

12. The system according to claim 8, wherein said historical demand values used to determine said demand distribution model comprises historical promotional demand values for said product.

13. The system according to claim 8, wherein said historical demand values used to determine said demand distribution model comprises historical values during out-of-stock periods for said product.

14. The system according to claim 8, wherein said product comprises an aggregation of related product items.

15. A non-transitory computer-readable medium having a computer program for managing product replenishment levers to increase product profitability, the computer program including executable instructions that cause a computer to:
determine a demand distribution model for said product from historical demand values;
determine an inventory costs model for said product from replenishment levers and inventory data for said product obtained from a replenishment system;
analyze said demand distribution model and said inventory costs model to identify values for the product replenishment levers to increase product profitability.

16. The non-transitory computer-readable medium having a computer program for managing product replenishment levers to increase product profitability in accordance with claim 15, wherein determining said inventory costs model comprises determining inventory carrying cost by analyzing at least one of cost of capital, inventory handling cost, labor cost, and insurance premiums.

17. The non-transitory computer-readable medium having a computer program for managing product replenishment levers to increase product profitability in accordance with claim 15, wherein said replenishment levers comprise at least one of lead time, review time, product pack-size, vendor minimum product order quantity, safety stock product quantity, minimum on shelf product quantity, and target service level.

18. The non-transitory computer-readable medium having a computer program for managing product replenishment levers to increase product profitability in accordance with claim 15, wherein said historical demand values used to determine said demand distribution model comprises historical regular demand values for said product.

19. The non-transitory computer-readable medium having a computer program for managing product replenishment levers to increase product profitability in accordance with claim 15, wherein said historical demand values used to determine said demand distribution model comprises historical promotional demand values for said product.

20. The non-transitory computer-readable medium having a computer program for managing product replenishment levers to increase product profitability in accordance with claim 15, wherein said historical demand values used to determine said demand distribution model comprises historical values during out-of-stock periods for said product.

21. The non-transitory computer-readable medium having a computer program for managing product replenishment levers to increase product profitability in accordance with claim 15, wherein said product comprises an aggregation of related product items.
